(19) United States
(12) Patent Application Publication
(10) Pub. No.: US 2024/0296296 A1
(43) Pub. Date: Sep. 5, 2024

(54) TRANSLATION OF RICH TEXT

(71) Applicant: INTERNATIONAL BUSINESS MACHINES CORPORATION, ARMONK, NY (US)

(72) Inventors: Jin Shi, NINGBO (CN); CHIH-YUAN LIN, New Taipei City (TW); Shu-Chih Chen, New Taipei City (TW); PEI-YI LIN, New Taipei City (TW); Chao Yuan Huang, Taipei (TW)

(21) Appl. No.: 18/177,467

(22) Filed: Mar. 2, 2023

(51) Int. Cl. G06F 40/42; G06F 40/103; G06F 40/30

(52) U.S. Cl. CPC G06F 40/42; G06F 40/103; G06F 40/30

(57) ABSTRACT

Embodiments of the present disclosure relate to a method, system, and computer program product for translation of rich text. In some embodiments, a method is disclosed. According to the method, one or more candidate formats are determined for source rich text. A target format for the source rich text is selected from the one or more candidate formats based on one or more corresponding images obtained from rendering the source rich text in the one or more candidate formats. Based on the target format, a translation editing environment is provided for editing a translation of the source rich text. In other embodiments, a system and a computer program product are disclosed.

### BACKGROUND

The present disclosure relates to computer science, and more specifically, to a method, system, and computer program product for translation of rich text.

Rich text refers to text formatted with one or more enriched text formats unavailable with plain text. The enriched text formats, also referred to as rich-text formats, may comprise formats such as a bold format, an italic format, a hyperlink format, typesetting formats, etc. The rich text can be supported in various types of files, e.g., a DOC file or a MARKDOWN file, to improve user experience. However, translation of the rich text from a source language to a target language may be difficult since some characters or elements in raw data of the rich text are used for representing the rich-text format instead of semantic contents of the rich text. For example, a translator may be confused when translating rich text, such as “**this formula**”. Thus, great efforts are needed for improvement of the translation of rich text.

### SUMMARY

According to one embodiment of the present disclosure, there is provided a computer implemented method. According to the method, the computer determines one or more candidate formats for source rich text. The computer obtains one or more images corresponding to the one or more candidate formats by rendering the source rich text in the one or more candidate formats. The computer selects, from the one or more candidate formats, a target format for the source rich text by validating the one or more candidate formats based on the one or more images. The computer provides, based on the target format, a translation editing environment for editing the translation of the source rich text.

According to another embodiment of the present disclosure, there is provided a system. The system comprises a processing unit and a memory coupled to the processing unit. The memory stores instructions that, when executed by the processing unit, perform actions comprising: determining one or more candidate formats for source rich text; obtaining one or more images corresponding to the one or more candidate formats by rendering the source rich text in the one or more candidate formats; selecting, from the one or more candidate formats, a target format for the source rich text by validating the one or more candidate formats based on the one or more images; and providing, based on the target format, a translation editing environment for editing the a translation of the source rich text.

According to yet another embodiment of the present disclosure, there is provided a computer program product. The computer program product is tangibly stored on machine-readable storage medium and comprises machine-executable instructions. The machine-executable instructions, when executed on a device, cause the device to perform actions comprising: determining one or more candidate formats for source rich text; obtaining one or more images corresponding to the one or more candidate formats by rendering the source rich text in the one or more candidate formats; selecting, from the one or more candidate formats, a target format for the source rich text by validating the one or more candidate formats based on the one or more images; and providing, based on the target format, a translation editing environment for editing the a translation of the source rich text.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computing environment for implementing the embodiments of the present disclosure.

FIG. 2 shows an exemplary process of providing a translation editing environment according to the embodiments of the present disclosure.

FIG. 3 shows an exemplary process of determining a candidate rich-text format for source rich text according to the embodiments of the present disclosure.

FIG. 4 shows an exemplary process of validating a candidate rich-text format according to the embodiments of the present disclosure.

FIG. 5 shows an exemplary process of rendering source rich text in a correct format and an incorrect format according to the embodiments of the present disclosure.

FIG. 6 shows an exemplary translation editor for editing the translation of source rich text according to the embodiments of the present disclosure.

FIG. 7 shows an exemplary flowchart of a method of providing a translation editing environment according to the embodiments of the present disclosure.

Throughout the drawings, same or similar reference numerals represent the same or similar elements.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable medium or machine-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Computing environment 100 contains an example of an environment for the execution of at least some of the computer code involved in performing the embodiments of the present disclosure, such as translation editing environment provision code 200. In addition to translation editing environment provision code 200, computing environment 100 may include, for example, computer 101, wide area network (WAN) 102, end user device (EUD) 103, remote server 104, public cloud 105, and private cloud 106. In this embodiment, computer 101 may include processor set 110 (which may include processing circuitry 120 and cache 121), communication fabric 111, volatile memory 112, persistent storage 113 (which may include operating system 122 and translation editing environment provision code 200, as identified above), peripheral device set 114 (which may include user interface (UI), device set 123, storage 124, and Internet of Things (IoT) sensor set 125), and/or network module 115. Remote server 104 may include remote database 130. Public cloud 105 may include gateway 140, cloud orchestration module 141, host physical machine set 142, virtual machine set 143, and container set 144.

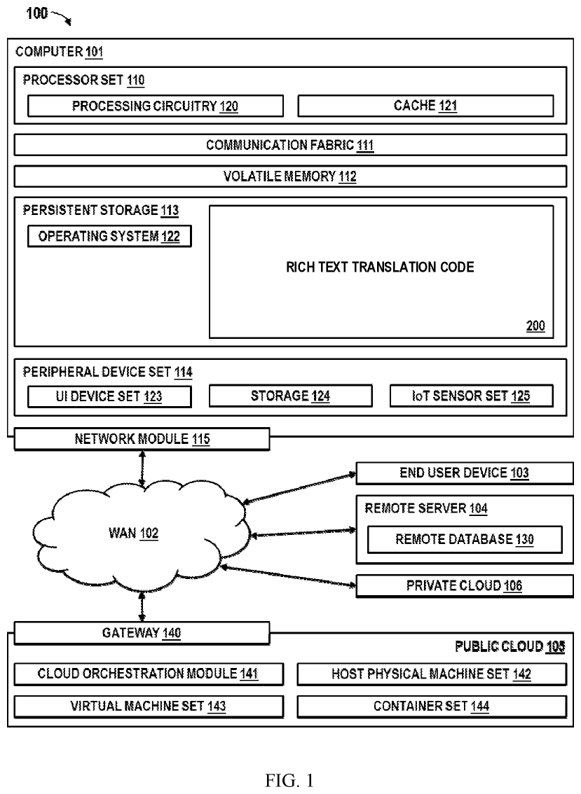

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. Performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 may include one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the methods”). These computer readable program instructions may be stored in various types of computer readable storage media, such as cache 121 and the other storage media discussed below. The program instructions, and associated data, are accessed by processor set 110 to control and direct performance of the methods. In computing environment 100, at least some of the instructions for performing the methods may be stored in translation editing environment provision code 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in translation editing environment provision code 200 typically includes at least some of the computer code involved in performing the methods.

PERIPHERAL DEVICE SET 114 may include the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is like public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is understood that the computing environment 100 in FIG. 1 is provided for illustration purpose without suggesting any limitation to any embodiment of the present disclosure, for example, at least part of the program code involved in performing the methods could be loaded in cache 121, volatile memory 112 or stored in other storage (e.g., storage 124) of the computer 101, or at least part of the program code involved in performing the methods could be stored in other local or/and remote computing environment and be loaded when need. For example, a peripheral device of the peripheral device set 114 could also be implemented by an independent peripheral device connected to the computer 101 through interface. For a further example, the WAN may be replaced and/or supplemented by any other connection made to an external computer (for example, through the Internet using an Internet Service Provider).

As described above, it may be difficult to translate rich text from a source language to a target language due to the rich-text format syntax of the rich text. Currently, some translation tools have been proposed to parse the rich-text format syntax and prevent non-translatable elements to be touched during the translation of the rich text. With these translation tools, a rich-text format may be identified for the rich text and used for the translation of the rich text.

However, source rich text to be translated may comprise rich-text segments with different rich-text format syntax. The rich-text segments with different rich-text format syntax may be passed to respective renderers or editors for rendering. For example, a rich-text segment formatted with the MARKDOWN format may be contained in the source rich text of a YAML file. In this case, it would be a great challenge to identify the rich-text format for translating the source rich text due to various syntax structures in the source rich text.

To at least partially solve the above and other potential problems, embodiments of the present disclosure provide a solution for the translation of rich text. According to the solution, one or more candidate formats are determined for source rich text. A target format for the source rich text is selected from the one or more candidate formats based on one or more corresponding images obtained from rendering the source rich text in the one or more candidate formats. In other words, the source rich text is rendered in each candidate format to obtain a respective image and the rendered images are used for determining the target format from the one or more candidate formats for the source rich text. Based on the target format, a translation editing environment is provided for editing a translation of the source rich text.

In this way, by identifying the target format for the source rich text and providing the translation editing environment catered for the target format, the translator can efficiently view and edit the translation of the source rich text in the translation editing environment, thereby reducing mistranslation of non-translatable elements in the source rich text.

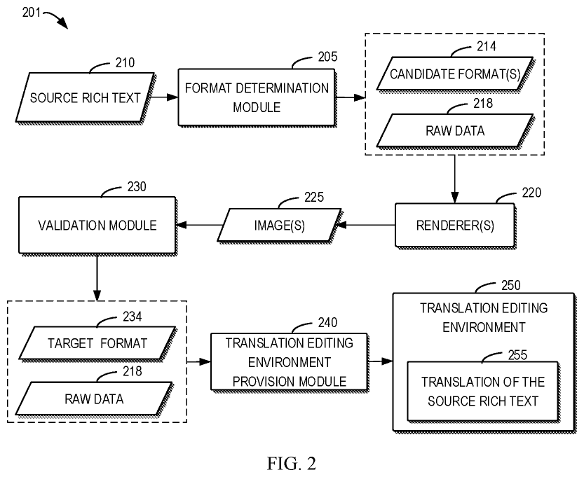

With reference now to FIG. 2, an exemplary process 201 of providing a translation editing environment for rich text according to the embodiments of the present disclosure is shown. It is to be understood that the exemplary process 201 is described for the purpose of illustration without suggesting any limitations as to the scope of the present disclosure. The embodiments of the present disclosure can be embodied with different elements or steps. For example, at least part or all of the process 201 may be implemented by translation editing environment provision code 200 of FIG. 1.

As shown in FIG. 2, a format determination module 205 may receive source rich text 210 to be translated and determine one or more candidate formats 214 for the source rich text 210.

The source rich text 210 may comprise source data formatted with one or more rich-text formats. In some embodiments, the source rich text 210 may comprise program integrated information (PII) comprising rich text. The term PII may refer to strings extracted from software codes. The PII may be stored in a PII file with a rich-text format, e.g., a HTML file, a YAML file, or a MARKDOWN file.

In some embodiments, the source rich text 210 may comprise PII strings with more than one rich-text formats. As an example, a YAML string content included in a YAML file is shown below.
example.yaml
string_key: refer to [hyperlink] (http://example.com) to get more details of **this topic**
   Wherein a rich-text segment “[hyperlink] (http://example.com)” and a rich-text segment “**this topic**” correspond to the MARKDOWN syntax instead of the YAML syntax. The rich-text segment “[hyperlink] (http://example.com)” may be rendered as a hyperlink and the rich-text segment “**this topic**” may be rendered as in the bold format.

As another example, an HTML string content included in a Java Properties file is shown below. The HTML string content and the other string contents in the Java Properties file may need to be rendered by different renderers.
Resource.properties:
Mailing.Panel3.DEFAULT_VIEW_MAILING_HTML_BODY=<CENTER><FONT SIZE=“1” COLOR=“{0}” FACE=“ARIAL”> If you are unable to see the message below, <A href=“{1}”>click here to view</A>.</FONT></CENTER>

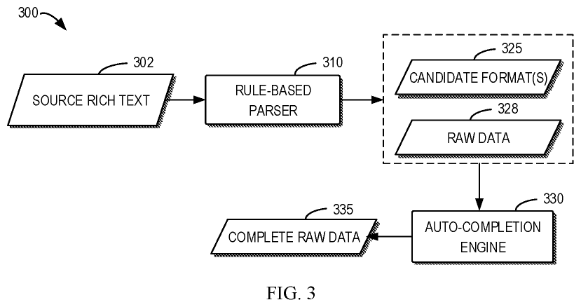

In some embodiments, the format determination module 205 may determine the candidate format(s) 214 for the source rich text 210 based on a textual analysis of the source rich text 210. The textual analysis may be performed by one or more suitable algorithms for analyzing the content, style, structure, purpose, and/or underlying meanings of the source rich text 210. An exemplary process of determining the candidate format(s) 214 is described with reference to FIG. 3.

The determined candidate format(s) 214 and raw data 218 of the source rich text 210 may be input to corresponding render(s) 220 to obtain corresponding image(s) 225. Specifically, for each candidate format, a respective render 220 is used to render the source rich text 210 in the candidate format to generate a respective image 225 containing the rendered source rich text. For example, a HTML renderer (e.g., a web browser) may render the source rich text 210 in a HTML rich-text format to obtain an image, and a MARKDOWN renderer may render the source rich text 210 in a MARKDOWN rich-text format to obtain a different image.

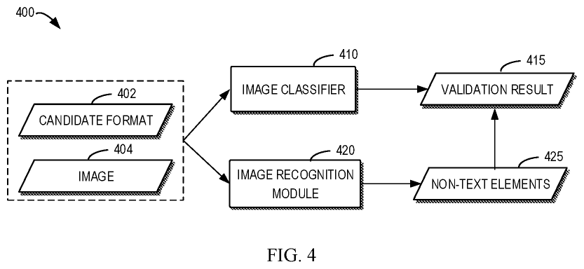

The image(s) 225 corresponding to the candidate format(s) 214 may be input to a validation module 230. The validation module 230 may select a target format 234 from the candidate format(s) 214 by validating the candidate format(s) 214 based on the corresponding image(s) 225. The validation module 230 may validate each candidate format 214 to check if it is suitable for rendering the source rich text 210 and determine the target format 234 from the candidate format(s) 214. In some embodiments, the validation module 230 may validate the candidate format(s) 214 by performing an image analysis of the corresponding image(s) 225. Further details of the validation process may be described with reference to FIG. 4.

The target format 234 and the raw data 218 of the source rich text 210 may be input to a translation editing environment provision module 240. The translation editing environment provision module 240 may provide a translation editing environment 250 for editing a translation 255 of the source rich text 210.

The translation editing environment 250 may comprise a translation editor implemented on an operating system. The translation editing environment 250 may be customized to support the target format 234 for the source rich text 210. In some embodiments, the translation editing environment 250 may be provided with a translation preview window displaying the translation 255 of the source rich text 210 after being rendered in the target format 234. As such, the translator can view the rendered translation and check if there is any mistranslation of the elements used for representing the rich-text format(s), thereby editing the translation 255 of the source rich text 210 more efficiently.

In some embodiments, the translation editing environment provision module 240 may invoke a translation service to determine a preliminary translation of the source rich text 210 with the determined target format 234 being considered. In this way, the elements representing the rich-text format may be prevented from translation, thereby improving the accuracy of the translation 255 of the source rich text 210.

With reference now to FIG. 3, an exemplary process 300 of determining a candidate format according to the embodiments of the present disclosure is shown. The process 300 may be performed by the format determination module 205 in FIG. 2.

As shown in FIG. 3, source rich text 302 may be input to a rule-based parser 310. The source rich text 302 may be the same or like the source rich text 210 in FIG. 2 and the details are omitted herein. The rule-based parser 310 may determine one or more candidate formats 325 for the source rich text 302 by applying written-in rules to the source rich text 302 to analyze the syntactic structures of the source rich text 302.

In some embodiments, the candidate format(s) 325 and the raw data 328 of the source rich text 302 are input to an auto-completion engine 330. The auto-completion engine 330 may fill in one or more missing parts of the source rich text 302 to obtain complete raw data 335. The complete raw data 335 may be used for translation and rendering of the source rich text 302, thereby improving the accuracy of the translation. In addition, although it is not shown in the figure, the complete raw data 335 may be input to the rule-based parser 310 for determining the candidate format(s) 325.

In some embodiments, the auto-completion engine 330 may auto-complete the missing part(s) based on the rich-text format syntax and/or semantic meanings of the source rich text 302. For example, the source rich text 302 may comprise an incomplete rich-text segment missing a tag and the auto-completion engine 330 may fill in the tag based on the tag dependency in the rich-text segment.

It is to be noted that the rule-based parser 310 and the auto-completion engine 330 may be implemented by any suitable algorithms and the scope of the present disclosure described herein is not limited in these aspects.

With reference now to FIG. 4, an exemplary process 400 of validating a candidate format according to the embodiments of the present disclosure is shown. The process 400 may be performed by the validation module 230 in FIG. 2.

As shown in FIG. 4, a candidate format 402 and the corresponding image 404 may be input to an image classifier 410 for validation of the candidate format 402. Alternatively, or in addition, the candidate format 402 and the corresponding image 404 may be input to an image recognition module 420 for the validation of the candidate format 402. The candidate format 402 and the image 404 may be the same as or like the candidate format 214 and the image 225 in FIG. 2, respectively. The details of the candidate format 402 and the image 404 are omitted herein.

In some embodiments, the image classifier 410 may perform image classification for the image 404 to validate whether the image 404 is obtained from rendering the source rich text in a correct rich-text format, i.e., if the candidate format 402 is suitable for rendering the source rich text.

The image classifier 410 may be a machine learning model trained based on a training dataset comprising positive examples and negative examples. The positive examples may comprise a first set of images each obtained from rendering respective information in a correct rich-text format and the negative examples may comprise a second set of images each obtained from rendering respective information in an incorrect rich-text format.

As such, the image classifier 410 may determine a validation result 415 indicating whether the image 404 is obtained from rendering the source rich text in a correct rich-text format. In other words, the validation result 415 may indicate whether the candidate format 402 is the suitable format for rendering the source rich text.

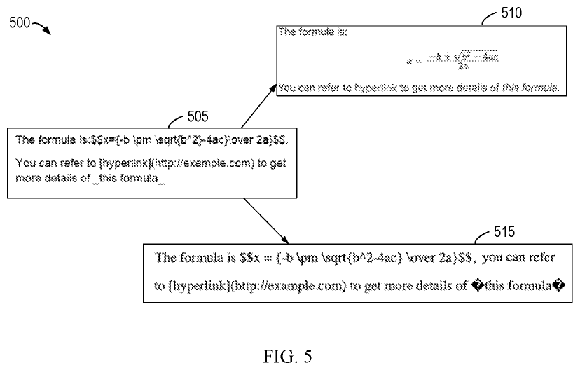

FIG. 5 shows an exemplary process 500 of rendering source rich text in a correct format and an incorrect format according to the embodiments of the present disclosure. FIG. 5 shows an example 505 of source rich text as in the form of raw data. FIG. 5 further shows an image 510 obtained from rendering the source rich text in a correct rich-text format and an image 515 obtained from rendering the source rich text in an incorrect rich-text format.

As can be seen from FIG. 5, when rendered in the correct format, a rich-text segment formatted with a formula format can be rendered as a formula instead of raw data with non-text elements such as “$$”, “\sqrt”, and “\hat{ }”. Moreover, a rich-text segment formatted with a hyperlink format can be rendered as a hyperlink instead of raw data with non-text elements such as “[” and “]”. The image 515 obtained from rendering the source rich text in the incorrect format may include non-text elements such as “?”, “$$”, “\sqrt”, “\hat{ }”, “[”, and “]”.

Referring to FIG. 4, the image recognition module 420 may perform image recognition for the image 404 to validate the candidate format 402. Specifically, the image recognition module 420 may recognize a plurality of elements in the image 404. The plurality of elements in the image 404 obtained from rendering the source rich text may comprise elements representing semantic contents of the source rich text and elements representing the rich-text format syntax. It is to be noted that necessary punctuations in a sentence may be considered as the elements representing the semantic contents.

The image recognition module 420 may further identify a number of non-text elements from the plurality of elements in the image 404. The number of non-text elements may comprise an element representing the rich-text format syntax. For example, in the image 515 in FIG. 5, the non-text elements may comprise “$”, “\sqrt”, “\hat{ }”, “[”, “]” and “?”.

In some embodiments, the image recognition module 420 may apply a natural language processing (NLP) model to the plurality of elements in the image 404 to identify elements of semantically complete text from the plurality of elements in the image 404. The semantically complete text may comprise a complete word or sentence in term of semantics. The image recognition module 420 may identify, from the plurality of elements, remaining elements other than the elements of semantically complete text as the non-text elements 425.

In some embodiments, the image recognition module 420 may determine a rich-text format for the remaining elements. The determined rich-text format may be different from the candidate format 402 and used for identifying a rich-text segment corresponding to this rich-text format. As such, when translating the source rich text comprising the rich-text segment corresponding to this rich-text format, better translation of the source rich text can be achieved.

The image recognition module 420 may determine the validation result 415 based on the number of non-text elements in the image 404. A smaller number of non-text elements may indicate higher validness or reasonableness of the candidate format 402. In some embodiments, the number of non-text elements may be compared with a predetermined threshold number of non-text elements for the validation.

Alternatively, or in addition, the image recognition module 420 may validate the candidate format 402 based on a layout of elements in the corresponding image 404. The image recognition module 420 may determine whether there are layout or format issues in the image 404. Examples of layout or format issues may include inappropriate tables, image location, and typesetting like indents. Alternatively, or in addition, the layout or format issues may be determined by any other suitable modules such as the image classifier 410. The scope of the present disclosure described herein is not limited in this aspect.

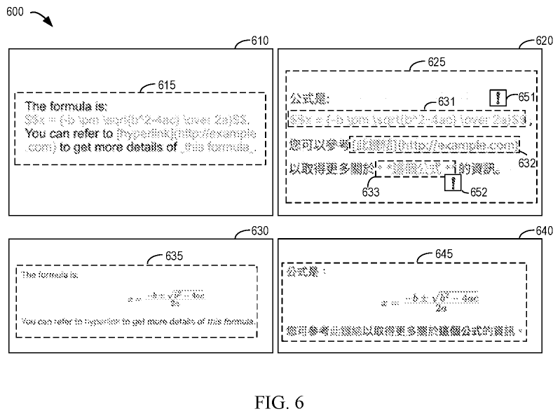

With reference now to FIG. 6, an exemplary translation editor 600 for editing the translation of rich text according to the embodiments of the present disclosure is shown. The translation editor 600 may be provided by the translation editing environment provision module 240 in FIG. 2. The translation editor 600 may be provided based on the determined target format 234 of the source rich text 210 to be translated. In other words, the translation editor 600 may be catered for the target format of the source rich text.

As shown in FIG. 6, the translation editor 600 may comprise a user interface comprising a source text editing window 610, a translation editing window 620, a source text viewing window 630 and a translation preview window 640. The source text editing window 610 may be configured to receive an input of source rich text to be translated, for example, source rich text 615. The source text editing window 610 may enable the translator to edit the source rich text 615. For example, the source rich text 615 may be modified, added, deleted, copied, or the like.

The source text viewing window 630 may be configured to display an image obtained from rendering the source rich text in the source text editing window 610. The translation editor 600 may render the source rich text in the determined target format to obtain the corresponding image and provide the image in the source text viewing window 630. For example, an image 635 corresponding to the source rich text 615 may be displayed in the source text viewing window 630.

The translation editing window 620 may be configured to enable the translator to edit a translation of the source rich text. In some embodiments, the translation editor 600 may obtain a preliminary translation of the source rich text 615 from a translation service and display the preliminary translation for further editing of the translator. Alternatively, the translation editing window 620 may be configured to receive a user input of the translation of the source rich text 615. For example, translation 625 of the source rich text 615 may be displayed in the translation editing window 620. The translation 625 may be generated from the translator or to be further edited by the translator.

The translation preview window 640 may be configured to display an image obtained from rendering the translation in the translation editing window 620. The translation editor 600 may render the translation in the translation editing window 620 in the target format to obtain the corresponding image and then display the image in the translation preview window 640. For example, an image 645 corresponding to the translation 625 in the translation editing window 620 may be displayed in the translation preview window 640.

As such, the translator can view the image obtained from rendering the translation of rich text conveniently, thereby editing the translation of rich text more accurately and efficiently. For example, the translator may understand that some elements correspond to a rich-text segment to be rendered later, and thus it would be inappropriate to translate the raw data of the rich-text segment.

In some embodiments, when providing the translation of source rich text in the translation editing window 620, the translation editor 600 may provide highlighting to a rich-text segment of interest. The rich-text segment of interest may be a rich-text segment with a specific rich-text format. The translation editor 600 may use different colors or other indications to highlight the rich-text format syntax of the rich-text segments. The translation editor 600 may provide the highlighting in the translation editing window 620 and/or the source text editing window 610.

For example, the translation editor 600 may provide highlighting to a rich-text segment 631 formatted with a formula format in MARKDOWN syntax, a rich-text segment 632 formatted with a hyperlink format in MARKDOWN syntax, and a rich-text segment 633 formatted with an italic format in MARKDOWN syntax.

In some embodiments, when providing the translation of source rich text in the translation editing window 620, the translation editor 600 may perform different actions for the rich-text segments with different rich-text format syntax.

For example, the translation editor 600 may provide a translation of the rich-text segment 632 in the translation of the source rich text 615. Alternatively, or in addition, the translation editor 600 may provide a translation of a rich-text segment with a converted rich-text format. The converted rich-text format may be determined based on cultural conventions associated with a source language of the source rich text and a target language of the translation.

A rule-based conversion may be used in the determination of the converted rich-text format. For example, when translating the source rich text which originally uses an italic format in a western language to Chinese, the italic format can be converted to a bold format that is used more widely in Chinese. As shown in FIG. 6, a rich-text segment 633 may be formatted with the converted rich-text format of the bold format.

Alternatively, or in addition, the translation editor 600 may provide a rich-text segment without being translated in the translation of the source rich text. The translation editor 600 may provide the rich-text segment in the source language in the translation editing window 620. For example, the translation editor 600 may provide the rich-text segment 631 as in the form of raw data in the source language.

In some embodiments, the translation editor 600 may provide, in the translation editing window 620, an indication avoiding modification to a rich-text segment in the translation of the source rich text. For example, the translation editor 600 may provide an indication 651 beside the rich-text segment 631 formatted with a formula format to avoid inappropriate translation of the formula.

In some embodiments, the translation editor 600 may provide, in the translation editing window 620, an indication of converting a source rich-text format of the rich-text segment in the source language into the converted rich-text format of the rich-text segment in the target language. For example, the translation editor 600 may provide an indication 652 beside the rich-text segment 633 with the converted rich-text format.

With the indication, the translator may manually edit the translation of the source rich text in the translation editing window 620. Alternatively, or in addition, the translation editor 600 may be provided with a utility to edit the translation of the source rich text to conform to cultural conventions or prevent illegal modifications to the translation.

In some embodiments, when providing the translation of source rich text in the translation editing window 620, the translation editor 600 may update the translation of the source rich text by removing an auto-completed part in the translation of the source rich text. The translation editor 600 may provide, in the translation editing window 620, the updated the translation of the source rich text.

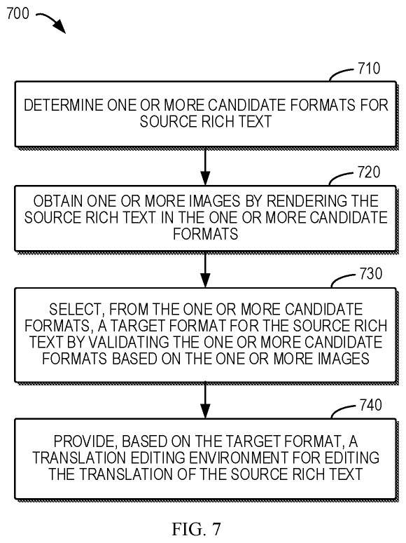

FIG. 7 shows an exemplary flowchart of a method 700 of providing a translation editor for editing the translation of rich text according to the embodiments of the present disclosure. The method 700 can be implemented by one or more processors executing translation editing environment provision code 200 in FIG. 1.

At block 710, one or more candidate formats are determined for source rich text.

In some embodiments, determining the one or more candidate formats for the source rich text may comprise: determining the one or more candidate formats by performing a textual analysis of the source rich text.

In some embodiments, performing the textual analysis of the source rich text may include applying, by the one or more processors, a rule-based parser to the source rich text.

In some embodiments, performing the textual analysis of the source rich text further may include filling, by the one or more processors, in a missing part of the source rich text to obtain complete raw data by applying an auto-completion engine to the source rich text.

At block 720, one or more images corresponding to the one or more candidate formats are obtained by rendering the source rich text in the one or more candidate formats.

At block 730, a target format for the source rich text is selected from the one or more candidate formats by validating the one or more candidate formats based on the one or more images.

In some embodiments, validating the one or more candidate formats based on the one or more images may include performing, by the one or more processors and for an image of the one or more images, image recognition to recognize a plurality of elements in the image. The validating the one or more candidate formats based on the one or more images may further include identifying, by the one or more processors, a number of non-text elements from the plurality of elements in the image. The validating the one or more candidate formats based on the one or more images may further include validating, by the one or more processors, a candidate format corresponding to the image in the one or more candidate formats based on the number of non-text elements in the image.

In some embodiments, identifying the number of non-text elements from the plurality of elements in the image may include identifying, by the one or more processors, elements of semantic ally complete text from the plurality of elements by applying a natural language processing (NLP) model to the plurality of elements in the image. The identifying the number of non-text elements from the plurality of elements in the image may further include identifying, by the one or more processors and from the plurality of elements in the image, remaining elements other than the elements of semantically complete text as the number of non-text elements.

In some embodiments, the target format may be a first rich-text format and the method 700 may include determining, by the one or more processors, a second rich-text format for the remaining elements and identifying, by the one or more processors, a rich-text segment corresponding to the second rich-text format from the source rich text.

In some embodiments, validating the one or more candidate formats based on the one or more images may include applying, by the one or more processors and for an image of the one or more images, an image classifier to the image to validate if the source rich text is rendered in a correct rich-text format, wherein the image classifier is trained based on a training dataset comprising positive examples and negative examples, wherein the positive examples comprise a first set of images each obtained from rendering respective information in a correct rich-text format and the negative examples comprise a second set of images each obtained from rendering respective information in an incorrect rich-text format.

In some embodiments, validating the one or more candidate formats based on the one or more images may include validating, by the one or more processors, the one or more candidate formats based on layouts of elements in the one or more corresponding images.

At block 740, a translation editing environment for editing the translation of the source rich text is provided based on the target format.

In some embodiments, providing the translation editing environment may comprise providing at least one of the following in a translation editor of the translation editing environment: a translation of a first rich-text segment in the source rich text, a translation of a second rich-text segment in the source rich text, the translation of the second rich-text segment being formatted with a converted rich-text format based on cultural conventions associated with a source language of the source rich text and a target language of the translation of the source rich text, or a third rich-text segment in the source rich text without being translated.

In some embodiments, providing the translation editing environment may include providing, by the one or more processors, an indication of converting a source rich-text format of a rich-text segment in the source rich text into a converted rich-text format for a translation of the rich-text segment in the translation of the source rich text.

In some embodiments, providing the translation editing environment may include providing, by the one or more processors, an indication of avoiding modification to a rich-text segment in the translation of the source rich text.

In some embodiments, providing the translation editing environment may include providing, by the one or more processors and in a translation editor of the translation editing environment, highlighting of a rich-text segment in the translation of the source rich text.

In some embodiments, providing the translation editing environment may include updating, by the one or more processors, the translation of the source rich text by removing an auto-completed part in the translation of the source rich text and providing, by the one or more processors, the updated translation of the source rich text in a translation editor of the translation editing environment.

In some embodiments, providing the translation editing environment may include providing, by the one or more processors, a translation preview window displaying an image obtained from rendering the translation of the source rich text in the target format.

In some embodiments, the source rich text may comprise program integrated information (PII).

It should be noted that the processing of translation of rich text according to embodiments of this disclosure could be implemented in the computing environment of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining one or more candidate formats for source rich text;
obtaining one or more images corresponding to the one or more candidate formats by rendering the source rich text in the one or more candidate formats;
selecting, from the one or more candidate formats, a target format for the source rich text by validating the one or more candidate formats based on the one or more images; and
providing, based on the target format, a translation editing environment for editing a translation of the source rich text.

2. The computer-implemented method of claim 1, wherein determining the one or more candidate formats for the source rich text comprises:
determining the one or more candidate formats by performing a textual analysis of the source rich text.

3. The computer-implemented method of claim 2, wherein performing the textual analysis of the source rich text comprises:
applying a rule-based parser to the source rich text.

4. The computer-implemented method of claim 3, wherein performing the textual analysis of the source rich text further comprises:
filling in a missing part of the source rich text to obtain complete raw data by applying an auto-completion engine to the source rich text.

5. The computer-implemented method of claim 1, wherein validating the one or more candidate formats based on the one or more images comprises:
performing, for an image of the one or more images, image recognition to recognize a plurality of elements in the image;
identifying a number of non-text elements from the plurality of elements in the image; and
validating a candidate format corresponding to the image in the one or more candidate formats based on the number of non-text elements in the image.

6. The computer-implemented method of claim 5, wherein identifying the number of non-text elements from the plurality of elements in the image comprises:
identifying elements of semantically complete text from the plurality of elements by applying a natural language processing (NLP) model to the plurality of elements in the image; and
identifying from the plurality of elements in the image, remaining elements other than the elements of semantically complete text as the number of non-text elements.

7. The computer-implemented method of claim 6, wherein the target format is a first rich-text format, and the method further comprises:
determining a second rich-text format for the remaining elements; and
identifying a rich-text segment corresponding to the second rich-text format from the source rich text.

8. The computer-implemented method of claim 1, wherein validating the one or more candidate formats based on the one or more images comprises:
applying, for an image of the one or more images, an image classifier to the image to validate if the source rich text is rendered in a correct rich-text format,
wherein the image classifier is trained based on a training dataset comprising positive examples and negative examples, wherein the positive examples comprise a first set of images each obtained from rendering respective information in a correct rich-text format and the negative examples comprise a second set of images each obtained from rendering respective information in an incorrect rich-text format.

9. The computer-implemented method of claim 1, wherein validating the one or more candidate formats based on the one or more images comprises:
validating the one or more candidate formats based on layouts of elements in the one or more corresponding images.

10. The computer-implemented method of claim 1, wherein providing the translation editing environment comprises providing at least one of the following in a translation editor of the translation editing environment:
a translation of a first rich-text segment in the source rich text,
a translation of a second rich-text segment in the source rich text, the translation of the second rich-text segment being formatted with a converted rich-text format based on cultural conventions associated with a source language of the source rich text and a target language of the translation of the source rich text, or
a third rich-text segment in the source rich text without being translated.

11. The computer-implemented method of claim 1, wherein providing the translation editing environment comprises:
providing an indication of converting a source rich-text format of a rich-text segment in the source rich text into a converted rich-text format for a translation of the rich-text segment in the translation of the source rich text.

12. The computer-implemented method of claim 1, wherein providing the translation editing environment comprises:
providing an indication of avoiding modification to a rich-text segment in the translation of the source rich text.

13. The computer-implemented method of claim 1, wherein providing the translation editing environment comprises:
providing, in a translation editor of the translation editing environment, highlighting of a rich-text segment in the translation of the source rich text.

14. The computer-implemented method of claim 1, wherein providing the translation editing environment comprises:
updating the translation of the source rich text by removing an auto-completed part in the translation of the source rich text; and
providing the updated translation of the source rich text in a translation editor of the translation editing environment.

15. The computer-implemented method of claim 1, wherein providing the translation editing environment comprises:
providing a translation preview window displaying an image obtained from rendering the translation of the source rich text in the target format.

16. The computer-implemented method of claim 1, wherein the source rich text comprises program integrated information (PII).

17. A system comprising:
a processing unit; and
a memory coupled to the processing unit and storing instructions thereon, the instructions, when executed by the processing unit, cause the processing unit to perform actions comprising:
determining one or more candidate formats for source rich text;
obtaining one or more images corresponding to the one or more candidate formats by rendering the source rich text in the one or more candidate formats;
selecting, from the one or more candidate formats, a target format for the source rich text by validating the one or more candidate formats based on the one or more images; and
providing, based on the target format, a translation editing environment for editing a translation of the source rich text.

18. The system of claim 17, wherein providing the translation editing environment comprises:
providing a translation preview window displaying an image obtained from rendering the translation of the source rich text in the target format.

19. The system of claim 17, wherein providing the translation editing environment comprises providing at least one of the following in a translation editor of the translation editing environment:
translation of a first rich-text segment in the source rich text,
translation of a second rich-text segment in the source rich text with a converted rich-text format based on cultural conventions associated with a source language and a target language, or
a third rich-text segment in the source rich text without being translated.

20. A computer program product stored on a machine-readable storage medium and comprising machine-executable instructions, the instructions, when executed on a device, cause the device to perform actions comprising:
determining one or more candidate formats for source rich text;
obtaining one or more images corresponding to the one or more candidate formats by rendering the source rich text in the one or more candidate formats;
selecting, from the one or more candidate formats, a target format for the source rich text by validating the one or more candidate formats based on the one or more images; and
providing, based on the target format, a translation editing environment for editing a translation of the source rich text.
